(19) United States
(12) Patent Application Publication
(10) Pub. No.: US 2019/0091995 A1
(43) Pub. Date: Mar. 28, 2019

(54) INK JET HEAD AND INK JET PRINTER

(71) Applicant: TOSHIBA TEC KABUSHIKI KAISHA, Tokyo (JP)

(72) Inventors: Noboru NITTA, Tagata Shizuoka (JP); Shunichi ONO, Izu Shizuoka (JP)

(21) Appl. No.: 16/140,722

(22) Filed: Sep. 25, 2018

(30) Foreign Application Priority Data
Sep. 25, 2017 (JP) 2017-183707

(51) Int. Cl. B41J 2/045

(52) U.S. Cl. CPC B41J 2/0455; B41J 2/04586; B41J 2/04541

(57) ABSTRACT

An ink jet head includes a first pressure chamber to be filled with ink, an actuator, a drive circuit including a first switch configured to turn on and connect a first power supply voltage to a first electrode on the first pressure chamber 1, a second switch configured to turn on and connect the first power supply voltage to a second electrode on a second pressure chamber adjacent to the first pressure chamber, a third switch configured to turn on and connect the first electrode to a ground potential, and a fourth switch configured to turn on and connect the second electrode to the ground potential, and a nozzle plate including a discharge nozzle through which the ink from the first pressure chamber is to be discharged.

### CROSS-REFERENCE TO RELATED APPLICATION

This application is based upon and claims the benefit of priority from Japanese Patent Application No. 2017-183707, filed Sep. 25, 2017, the entire contents of which are incorporated herein by reference.

### FIELD

Embodiments described herein relate generally to an ink jet head and an ink jet printer.

### BACKGROUND

An ink jet printer that forms an image on a print medium according to print data has been put to practical use. An ink jet printer includes an inkjet head and a head controller that controls ejection of ink from the ink jet head. The ink jet head includes an actuator that discharges ink and a driver that drives the actuator based on a control of the head controller. The actuator includes a plurality of grooves formed in a piezoelectric member and electrodes. The electrodes are formed so as to sandwich a portion of the piezoelectric member which forms a sidewall of a groove. Ink flows into the groove. The actuator is deformed according to a difference in potential between the electrodes sandwiching the piezoelectric member. When the actuator is deformed, the ink flowing into the groove is discharged.

With such a configuration, each electrode is maintained at a power supply voltage level for electric discharging at the end of the driving of the ink jet head. In this state, when there is any member in contact with the ink is at a ground potential, electrophoresis (an electrophoretic separation of components in the ink) may occur in the ink, and the ink may be deteriorated by this process. Likewise, the electrode material may corrode and the life of the actuator may be shortened.

### DESCRIPTION OF THE DRAWINGS

FIG. 1 is an explanatory diagram an ink jet printer according to a first embodiment.

FIG. 2 is an explanatory diagram of an ink jet head according to the first embodiment

FIG. 3 is a cross-sectional view of one channel of an ink jet head.

FIG. 4 is a cross-sectional view of the inkjet head taken along the line A-A in FIG. 3.

FIGS. 5A and 5B are explanatory diagrams of deformations of an actuator of an ink jet head.

FIG. 6 is an explanatory diagram of a drive IC.

FIG. 7 is an explanatory diagram of a drive control circuit.

FIG. 8 is an explanatory diagram of a drive circuit.

FIG. 9 is an explanatory diagram of a buffer.

FIG. 10 is an explanatory diagram of a buffer.

FIG. 11 is an explanatory diagram of an operation example of a drive control circuit.

FIG. 12 is an explanatory diagram of a drive control circuit according to a second embodiment.

FIG. 13 is an explanatory diagram of a drive control circuit.

### DETAILED DESCRIPTION

In general, according to an embodiment, an ink jet head includes a pressure chamber to be filled with ink, an actuator configured to deform the pressure chamber, first and second electrodes connected to the actuator, a drive circuit, and a nozzle plate. The drive circuit includes a first switch configured to turn on and connect a first power supply voltage to the first electrode and a second switch configured to turn on and connect the first power supply voltage to the second electrode. The drive circuit also includes a third switch configured to turn on and connect the first electrode to a ground potential and a fourth switch configured to turn on and connect the second electrode to the ground potential. The nozzle plate includes a discharge nozzle through which the ink from the pressure chamber is discharge. The drive circuit is configured to expand the pressure chamber to an expanded state, by switching the first switch off and the third switch on. The drive circuit is configured to contract the pressure chamber to a contracted state, by switching the first switch on and the third switch off and the second switch off and the fourth switch on. The drive circuit is configured to cause the pressure chamber to return to a steady state by switching the first switch and the second switch on and switching the third switch and the fourth switch off. The drive circuit is configured to switch the first switch and the second switch off after the pressure chamber has returned to the steady state and a predetermined time has elapsed.

### First Embodiment

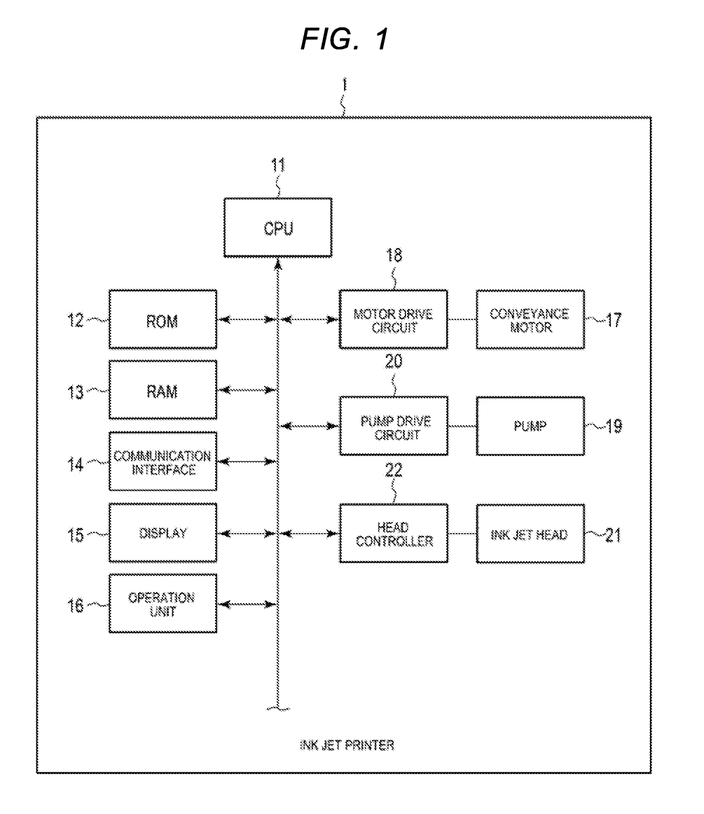

First, an ink jet printer 1 according to a first embodiment will be described. FIG. 1 is an explanatory diagram of the ink jet printer 1 according to the first embodiment.

The inkjet printer 1 is an example of an inkjet recording apparatus. The ink jet recording apparatus is not limited to those specifically depicted and may be another apparatus such as a copying machine.

The ink jet printer 1 performs various processes such as image formation while conveying a print medium (for example, a recording medium). The inkjet printer 1 includes a central processing unit (CPU) 11, a read only memory (ROM) 12, a random access memory (RAM) 13, a communication interface 14, a display 15, an operation unit 16, a conveyance motor 17, a motor drive circuit 18, a pump 19, a pump drive circuit 20, an inkjet head 21, and a head controller 22. Furthermore, the ink jet printer 1 includes a paper feed cassette and a paper discharge tray which are not illustrated.

The CPU 11 is an arithmetic element (for example, a processor) that executes arithmetic processes. The CPU 11 performs various processes based on data such as a program stored in the ROM 12. The CPU 11 functions as a control unit capable of executing various operations by executing the program stored in the ROM 12.

The ROM 12 is a read-only non-volatile memory. The ROM 12 stores a program and data used by the program.

The RAM 13 is a volatile memory functioning as a working memory. The RAM 13 temporarily stores data or the like being processed by the CPU 11. The RAM 13 temporarily stores programs being executed by the CPU 11.

The communication interface 14 is an interface for communicating with other devices. The communication interface 14 is used for communication with, for example, a host device that transmits print data to the ink jet printer 1. The communication interface 14 may perform wireless communication with other devices according to standards such as Bluetooth® or Wi-Fi.

The display unit 15 is a display device which displays a screen according to a video signal input from the CPU 11 or a display control unit such as a graphic controller (not specifically depicted). on the display unit 15, a setting screen of the ink jet printer 1 is displayed, for example.

The operation unit 16 generates an operation signal based on a user's operation. The operation unit 16 is, for example, a touch sensor, a ten key, a power button, a paper feed key, various function keys, a keyboard, or the like. The touch sensor is, for example, a resistive touch sensor ora capacitive touch sensor. The touch sensor acquires information indicating a position within a certain area that has been touched. The touch sensor can be a touch panel integrated with the display 15 and generate a signal indicating a touched position on a screen displayed on the display 15.

The conveyance motor 17 operates a conveyance member on a conveyance path (not specifically depicted) for conveying the print medium by rotating the conveyance member. The conveyance member is, for example, a belt, a roller, and a guide operate to convey the print medium. The conveyance motor 17 conveys the print medium along a guide by driving a roller operating in conjunction with a belt that holds the print medium.

The motor drive circuit 18 is a circuit that drives the conveyance motor 17. The motor drive circuit 18 drives the conveyance motor 17 according to the conveyance control signal input from the CPU 11 to convey the print medium from the paper feed cassette to the paper discharge tray via a position facing the ink jet head 21. The paper feed cassette is a cassette that accommodates a plurality of print media. An image is formed on the print media by the ink jet printer 1 and then the print media is discharged.

The pump 19 includes a tube that communicates the ink jet head 21 with, for example, an ink tank (not specifically depicted). Specifically, the tube communicates with a common ink chamber (not specifically depicted) of the ink jet head 21.

The pump drive circuit 20 supplies ink from the ink tank to the common ink chamber of the ink jet head 21 by driving the pump 19 according to the ink supply control signal input from the CPU 11.

The ink jet head 21 is an image forming unit that forms an image on the print medium. The ink jet head 21 forms an image on the print medium by discharging ink onto the print medium held by a holding roller (not specifically depicted). The ink jet printer 1 may include multiple ink jet heads 21 corresponding to different colors such as cyan, magenta, yellow, and black, for example.

The head controller 22 is a circuit for controlling the ink jet head 21. The head controller 22 discharges ink from the ink jet head 21 by operating the ink jet head 21. The head controller 22 inputs print data, a printing trigger, a power supply voltage VAA for operating the ink jet head 21, and a power supply voltage VCC to the ink jet head 21. Thus, the head controller 22 causes the ink jet head 21 to form an image according to the print data on the print medium.

The print data is data indicating whether to discharge ink from particular channels. The print data includes any one or a combination of H-level signals and L-level signals.

The printing trigger is a signal output when an operation to discharge ink is carried out.

Further, the ink jet printer 1 may include a power supply circuit that converts AC power supplied from a commercial power supply to DC power and supplies this DC power to components in the ink jet printer 1.

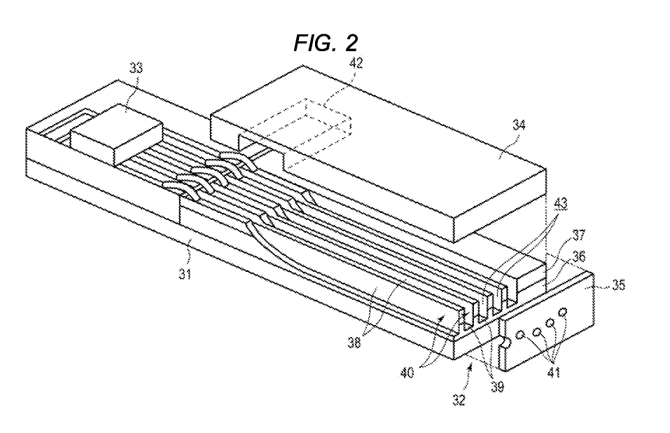

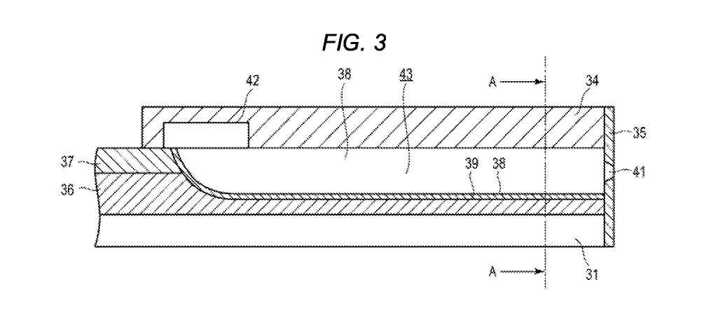

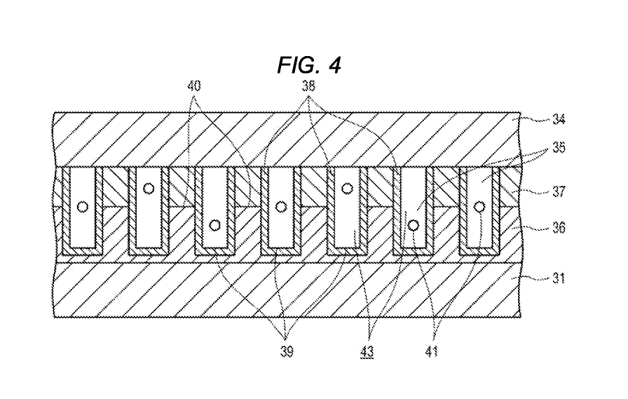

FIGS. 2 to 4 depict configuration examples of the ink jet head 21. FIG. 2 is a partial perspective view of the ink jet head 21 in a disassembled state. FIG. 3 is a cross-sectional view of one channel of the ink jet head 21. FIG. 4 is a cross-sectional view of the ink jet head 21 taken along the line A-A in FIG. 3. It is noted that in FIG. 4, the discharge nozzles 41 are depicted for the illustrative purpose, although the discharge nozzles 41 are not formed at the cross section taken along the line A-A.

The ink jet head 21 includes a head substrate 31, a channel group 32, and a drive integrated circuit (IC) 33. In FIG. 2, a top plate 34 and a nozzle plate 35 of the channel group 32 are illustrated in a disassembled state.

The head substrate 31 is a substrate on which the channel group 32 and the drive IC 33 are mounted. The head substrate 31 is made of a ceramic substrate, or alternatively may be made of a glass or epoxy substrate or a flexible substrate using a polyimide film as a base material.

The channel group 32 is made of a plurality of channels for discharging ink according to the applied voltage. The channel group 32 includes a first piezoelectric member 36 joined to the head substrate 31, a second piezoelectric member 37 joined to the first piezoelectric member 36, a plurality of electrodes 38, the top plate 34, and the nozzle plate 35.

The first piezoelectric member 36 and the second piezoelectric member 37 are formed of, for example, lead zirconate titanate, which is a piezoelectric (PZT) material. The first piezoelectric member 36 is joined to the head substrate 31. The second piezoelectric member 37 is joined to the first piezoelectric member 36 so that the polarization direction of the second piezoelectric member 37 is opposite to that of the first piezoelectric member. A plurality of parallel grooves 39 extending from the second piezoelectric member 37 to the first piezoelectric member 36 are formed within the joined member of the first piezoelectric member 36 and the second piezoelectric member 37.

The electrode 38 is formed over a pair of walls and a bottom surface forming the groove 39 of the first piezoelectric member 36 and the second piezoelectric member 37. The electrode 38 is formed for each groove 39. Thus, the first piezoelectric member 36 and the second piezoelectric member 37 forming the wall of the groove 39 are sandwiched between two adjacent electrodes 38. The first piezoelectric member 36 and the second piezoelectric member 37 sandwiched between the two adjacent electrodes 38 acts as an actuator 40 that is deformed by a potential difference between the two adjacent electrodes 38.

The nozzle plate 35 is a member that seals the grooves 39 together with the top plate 34. The nozzle plate 35 is formed so as to close a longitudinal end of the groove 39. A plurality of discharge nozzles 41 is formed in the nozzle plate 35 to communicate the groove 39 with the outside of the ink jet head 21. The discharge nozzle 41 is formed for each groove 39.

The top plate 34 is a member that seals the groove 39 together with the nozzle plate 35. The top plate 34 seals the groove 39 from the side opposed to the head substrate 31. Further, a part of the surface of the top plate 34 contacting with the groove 39 is formed as a recess 42. The recess 42 communicates with a tube of the pump 19, and functions as a common ink chamber for temporarily holding the ink supplied by the tube. In addition, the recess 42 communicates with an end on the opposite side to the end of the groove 39 contacting with the nozzle plate 35, and supplies the ink contained in the common ink chamber to the groove 39.

The plurality of grooves 39 is sealed by the nozzle plate 35 and the top plate 34, whereby a pressure chamber 43 is formed. That is, the pressure chamber 43 is a space surrounded by the pair of actuators 40, the nozzle plate 35, and the top plate 34 and communicating with the common ink chamber. Further, the pressure chamber 43 is formed for each discharge nozzle 41 in the nozzle plate 35. In the example embodiment described herein, a combination of one of the electrodes 38 and a corresponding one of the discharge nozzles 41 is referred to as a channel. The number of channels in the channel group 32 corresponds to the number of grooves 39.

The drive IC 33 deforms the actuator 40 by inputting a signal to the actuator 40 forming the wall of the pressure chamber 43, thereby changing the volume of the pressure chamber 43. Thus, the drive IC 33 controls a pressure of the pressure chamber 43, and discharges the ink contained in the pressure chamber 43 from the discharge nozzle 41.

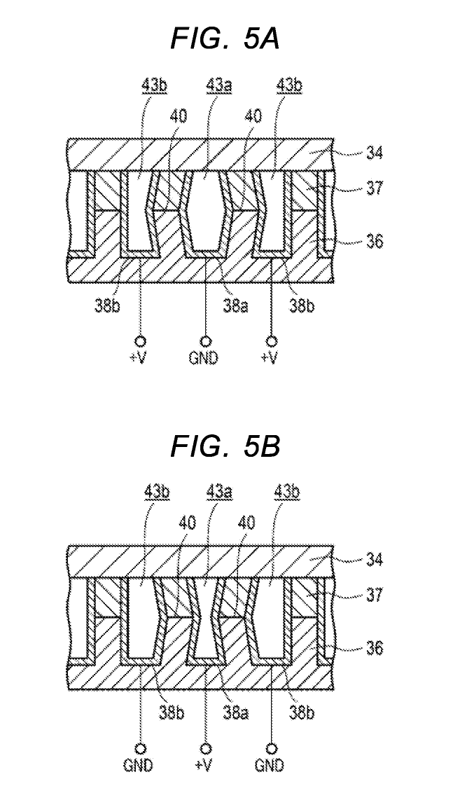

FIGS. 5A and 5B are explanatory diagrams deformations of the actuator 40 when a potential difference occurs between the two adjacent electrodes sandwiching the actuator 40. When the potential difference does not occur between the two adjacent electrodes 38, the actuator 40 is not deformed as in FIG. 4. A state of the pressure chamber 43 when the actuator 40 is not deformed is referred to as an initial state.

FIG. 5A illustrates an example in which a potential of an electrode 38a in a pressure chamber 43a of a target channel is GND and a potential of an electrode 38b in a pressure chamber 43b of an adjacent channel +V. In this case, as illustrated in FIG. 5A, an electric field of a voltage V is generated in a direction orthogonal to the polarization direction at the first piezoelectric member 36 and the second piezoelectric member 37 of the actuator 40 sandwiched between the electrode 38a and the electrode 38b. Due to the electric field, the actuator 40 expands the volume of the pressure chamber 43a from the initial state to the expanded state, and reduces the pressure in the pressure chamber 43.

FIG. 5B illustrates an example in which a potential of the electrode 38a in a pressure chamber 43a of a channel is +V and a potential of the electrode 38b in the pressure chamber 43b of an adjacent channel GND. In this case, as illustrated in FIG. 5B, an electric field of a voltage V is generated in a direction opposite to the example of FIG. 5A in the direction orthogonal to the polarization direction at the first piezoelectric member 36 and the second piezoelectric member 37 of the actuator 40 sandwiched between the electrode 38a and the electrode 38b. Due to the electric field, the actuator 40 contracts the volume of the pressure chamber 43a from the initial state to the contracted state, and increases the pressure in the pressure chamber 43.

As described above, the actuator 40 forming the wall of the pressure chamber 43 is deformed, and the volume thereof is switched between the initial state, the expanded state, and the contracted state, whereby the pressure in the pressure chamber 43 is changed. When the pressure in the pressure chamber 43 decreases, ink is drawn into the pressure chamber 43 from the common ink chamber. When the pressure in the pressure chamber 43 increases, the ink in the pressure chamber 43 is discharged from the discharge nozzle 41.

As described above, the pressure chamber 43 of a channel shares the actuator 40 with the pressure chamber 43 of the adjacent channel. For this reason, the drive IC 33 does not control the pressure in the pressure chamber 43 for each channel, but controls the pressure in the pressure chamber 43 for each group of n channels (n is an integer of 2 or more). The examples depicted in FIGS. 5A and 5B indicate that the pressure in the pressure chamber 43 is controlled using three channels as one group.

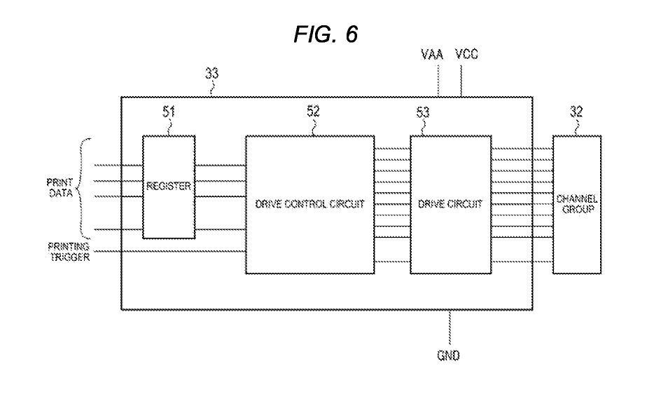

FIG. 6 is an explanatory diagram of the drive IC 33.

The drive IC 33 deforms the actuator 40 of the channel group 32 by switching the potentials of the electrodes 38 of the channel group 32 based on the signals of the print data and the printing trigger input from the head controller 22. A plurality of output terminals for outputting the drive signal of the drive IC 33 is each connected to the electrodes 38 for each channel of each channel group 32.

The drive IC 33 includes a register 51, a drive control circuit 52, and a drive circuit 53.

The register 51 temporarily stores the print data input from the head controller 22. The register 51 supplies the stored print data to the drive control circuit 52 in the order of storage. The register 51 is, for example, a FIFO.

The drive control circuit 52 generates a drive signal for each channel based on the print data and the printing trigger supplied from the register 51. The drive control circuit 52 supplies the generated drive signal to the drive circuit 53.

For example, the drive control circuit 52 generates a drive signal to be supplied to the drive circuit 53 using a predetermined waveform pattern. For example, the drive control circuit 52 combines an expansion signal (referred to as an “ACT waveform”) for setting the volume of the pressure chamber 43 in an expanded state, a contraction signal (referred to as an “INACT waveform”) for setting the volume of the pressure chamber 43 in a contracted state, and a steady state (in which the volume of the pressure chamber 43 is not deformed), based on the print data, thereby generating the drive signal.

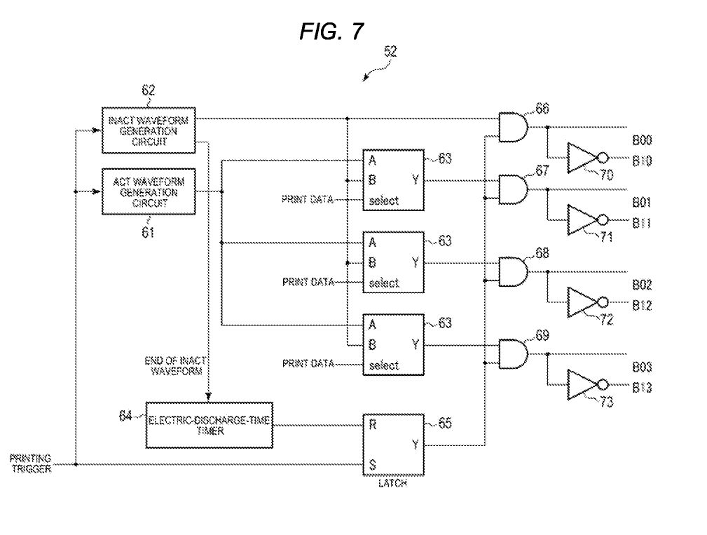

FIG. 7 is an explanatory diagram of the drive control circuit 52. The drive control circuit 52 includes an ACT waveform generation circuit 61, an INACT waveform generation circuit 62, a plurality of selectors 63, an electric-discharge-time timer 64, a latch circuit 65, a first AND circuit 66, a second AND circuit 67, a third AND circuit 68, a fourth AND circuit 69, a first inverter circuit 70, a second inverter circuit 71, a third inverter circuit 72, and a fourth inverter circuit 73. FIG. 7 illustrates a part of the drive control circuit 52, and the drive control circuit 52 further includes a large number of selectors, AND circuits, and inverter circuits. For example, the drive control circuit 52 includes a selector, an AND circuit, and an inverter circuit for each channel.

The ACT waveform generation circuit 61 is a circuit that outputs an ACT waveform. The ACT waveform generation circuit 61 outputs the ACT waveform when the printing trigger is switched to ON.

The INACT waveform generation circuit 62 is a circuit that outputs an INACT waveform. The INACT waveform generation circuit 62 outputs the INACT waveform when the printing trigger is switched to ON.

The selector 63 is connected to an output terminal of the ACT waveform generation circuit 61 and an output terminal of the INACT waveform generation circuit 62. Further, the selector 63 is connected to an output terminal of the register 51. Based on the print data supplied from the register 51, the selector 63 switches the signal output from the output terminal into the ACT waveform supplied from the ACT waveform generation circuit 61 and the INACT waveform supplied from the INACT waveform generation circuit 62.

An electric-discharge-time timer 64 is connected to the output terminal of the INACT waveform generation circuit 62. The electric-discharge-time timer 64 outputs a pulse signal after a lapse of a predetermined time (referred to as an electric-discharge time) from the INACT waveform output from the INACT waveform generation circuit 62.

The latch circuit 65 is set (set to ON) when the printing trigger is input to an S (set) terminal thereof, and reset (set to OFF) when a pulse signal is input to a R (reset) terminal thereof in accordance with time-up of the electric-discharge-time timer 64.

The first AND circuit 66 is connected to an output terminal of the INACT waveform generation circuit 62 and an output terminal of the latch circuit 65. The first AND circuit 66 outputs an ON-signal when the signal from the INACT waveform generation circuit 62 is ON and the signal from the latch circuit 65 is ON. The signal from the first AND circuit 66 is supplied as a signal BOO to a buffer circuit of the drive circuit 53. In addition, the signal from the first AND circuit 66 is inverted via the first inverter circuit 70, and is supplied as a signal B10 to the buffer circuit of the drive circuit 53.

The second AND circuit 67 is connected to an output terminal of the selector 63 and an output terminal of the latch circuit 65. The second AND circuit 67 output an ON-signal when the signal of the selector 63 is ON and the signal from the latch circuit 65 is ON. The signal from the second AND circuit 67 is supplied as a signal B01 to the buffer circuit of the drive circuit 53. Further, the signal from the second AND circuit 67 is inverted via the second inverter circuit 71, and is supplied as a signal B11 to the buffer circuit of the drive circuit 53.

The third AND circuit 68 is connected to the output terminal of the selector 63 and the output terminal of the latch circuit 65. The third AND circuit 68 outputs an ON-signal when the signal from the selector 63 is ON and the signal from the latch circuit 65 is ON. The signal from the third AND circuit 68 is supplied as a signal B02 to the buffer circuit of the drive circuit 53. Further, the signal from the third AND circuit 68 is inverted via the third inverter circuit 72, and is supplied as a signal B12 to the buffer circuit of the drive circuit 53.

The fourth AND circuit 69 is connected to the output terminal of the selector 63 and the output terminal of the latch circuit 65. The fourth AND circuit 69 outputs an ON-signal when the signal from the selector 63 is ON and the signal from the latch circuit 65 is ON. The signal from the fourth AND circuit 69 is supplied as a signal B03 to the buffer circuit of the drive circuit 53. Further, the signal from the fourth AND circuit 69 is inverted via the fourth inverter circuit 73, and is supplied as a signal B13 to the buffer circuit of the drive circuit 53.

The output of the AND circuit and the output of the inverter circuit correspond one channel. That is, a combined signal of the signal BOO and the signal B10, a combined signal of the signal B01 and the signal B11, a combined signal of the signal B02 and the signal B12, and a combined signal of the signal B03 and the signal B13 are supplied to the drive circuit 53 so as to correspond to one channel, respectively. Since the signals B10, B11, B12, and B13 are respectively obtained by inversion of the outputs of the AND circuits, the signals BOO and B10, the signals B01 and B11, the signals B02 and B12, and the signals B03 and B13 are inverted in logic, respectively.

The drive circuit 53 switches the potential of the electrode 38 of each channel based on the drive signal supplied from the drive control circuit 52, a power supply voltage VAA, and GND. Thus, the drive circuit 53 gives a drive waveform to the electrode 38 forming the actuator 40. That is, the drive waveform is a voltage applied to the actuator 40.

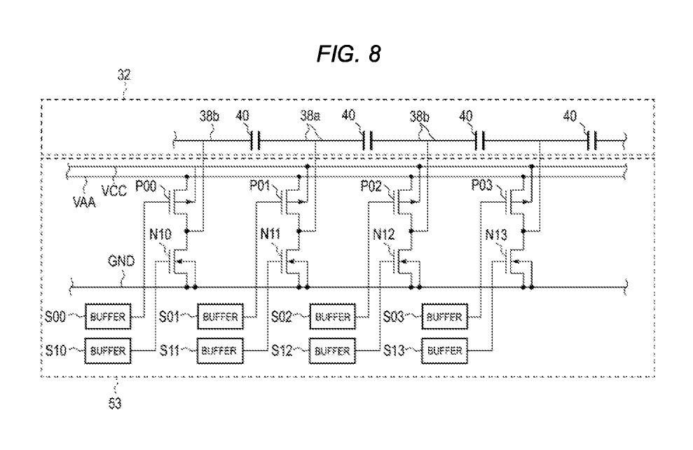

FIG. 8 is an explanatory diagram of the drive circuit 53. The drive circuit 53 includes buffers S00, S01, S02, S03, S10, S11, S12, and S13, semiconductor switches P00, P01 P02, P03, N10, N11, N12, N13. FIG. 8 illustrates apart of the drive circuit 53, and the drive circuit 53 further includes a large number of buffers and semiconductor switches. For example, the drive circuit 53 includes, for each channel, a pair of semiconductor switches whose conductive paths are connected in series and a buffer connected to the control terminal (also referred to as a gate terminal) of each of the semiconductor switches.

The buffer S00 is a circuit that receives the signal BOO from the drive control circuit 52. The buffer S01 is a circuit that receives the signal B01 from the drive control circuit 52. The buffer S02 is a circuit that receives the signals B02 from the drive control circuit 52. The buffer S03 is a circuit that receives the signal B03 from the drive control circuit 52. The buffer S10 is a circuit that receives the signal B10 from the drive control circuit 52. The buffer S11 is a circuit that receives the signal B11 from the drive control circuit 52. The buffer S12 is a circuit that receives the signal B12 from the drive control circuit 52. The buffer S13 is a circuit that receives the signal B13 from the drive control circuit 52.

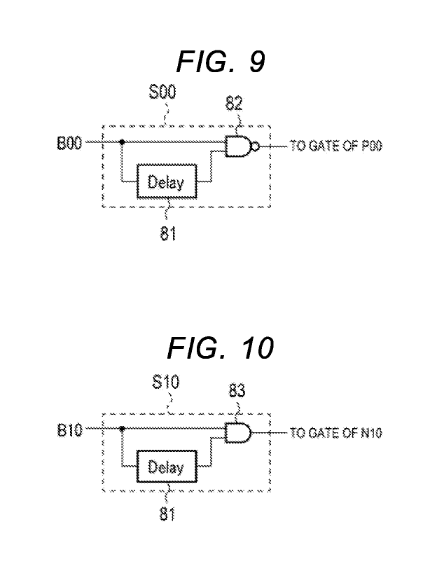

The buffers S00, S01, S02, and S03 in a first buffer group are connected to the output terminals of the AND circuits of the drive control circuit 52. The buffers S00, S01, S02, and S03 have the same configuration. FIG. 9 is a diagram of the buffer S00. The buffer S00 includes a NAND circuit 82 having one terminal directly connected to an input terminal and the other terminal connected to the input terminal through a delay circuit 81. The delay circuit 81 is a circuit that delays and outputs the input signal. That is, when the input signal BOO is switched from OFF to ON, the buffer S00 delays the signal by a time according to the characteristic of the delay circuit 81 and switches an output signal from High to Low.

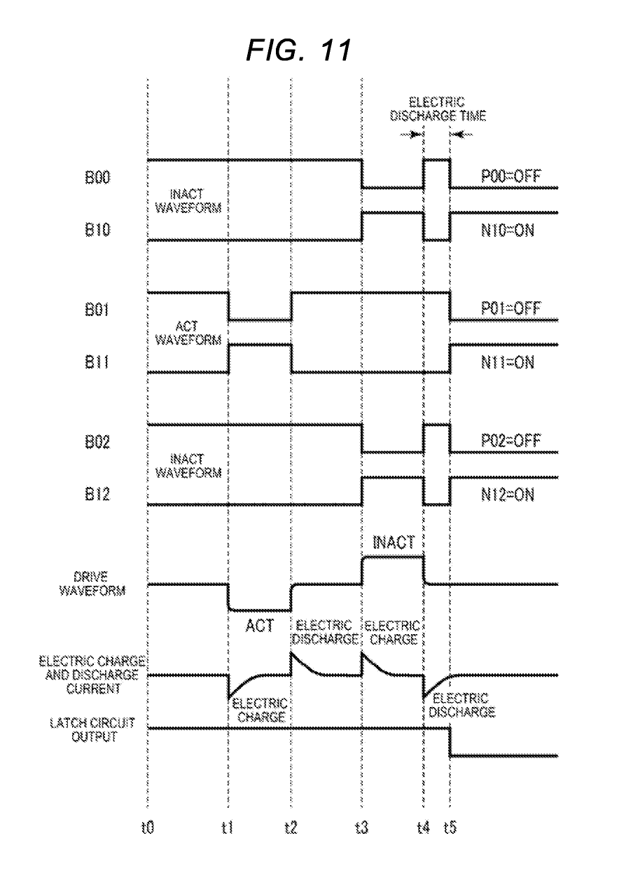

The buffers S10, S11, S12, and S13 in a second buffer group are connected to the output terminals of the inverter circuits of the drive control circuit 52. The buffers S10, S11, S12, and S13 have the same configuration. FIG. 10 is a diagram of the buffer S10. The buffer S10 includes a AND circuit 83 having one terminal directly connected to an input terminal and the other terminal connected to the input terminal through a delay circuit 81. That is, when the input signal B10 is switched from OFF to ON, the buffer S10 delays the signal by a time according to the characteristic of the delay circuit 81 and switches an output signal from Low to High.

The semiconductor switches P00, P01, P02, P03, N10, N11, N12, and N13 are, for example, field effect transistors.

The semiconductor switches P00, P01, P02, and P03 are, for example, P-type channel MOSFETs. The semiconductor switches P00, P01, P02, and P03 electrically connect a drain with a source when an ON-signal (that is a low-level signal) is input to a gate terminal.

In each of the semiconductor switches P00, P01, P02, and P03, a source terminal is connected to a power supply voltage VAA, a drain terminal is connected to the electrode 38 formed across a pair of actuators 40 forming a channel corresponding thereto, and a back gate is connected to a power supply voltage VCC. In addition, each of the semiconductor switches P00, P01, P02, and P03 includes a gate terminal that is connected to a respective one of the buffers of the first buffer group. The gate terminal of the semiconductor switch P00 is connected to the buffer S00. The gate terminal of the semiconductor switch P01 is connected to the buffer S01. The gate terminal of the semiconductor switch P02 is connected to the buffer S02. The gate terminal of the semiconductor switch P03 is connected to the buffer S03.

The semiconductor switches N10, N11, N12, and N13 are, for example, N-type channel MOSFETs. The semiconductor switches N10, N11, N12, and N13 electrically connect a drain with a source when an ON-signal (that is a high-level signal) is input to the gate terminal.

Each of the semiconductor switches N10, N11, N12, and N13 includes a source terminal that is connected to a GND, a drain terminal that is connected to the drain terminal of each of the semiconductor switches P00, P01, P02, and P03, and a back gate that is connected to the GND. In addition, each of the semiconductor switches N10, N11, N12, and N13 includes a gate terminal that is connected to a respective one of the buffers of the second buffer group. The gate terminal of the semiconductor switch N10 is connected to the buffer S10. The gate terminal of the semiconductor switch N11 is connected to the buffer S11. The gate terminal of the semiconductor switch N12 is connected to the buffer S12. The gate terminal of the semiconductor switch N13 is connected to the buffer S13.

In the example embodiment described below, ink is discharged from the channels corresponding to the buffers S01 and S11, the semiconductor switches P01 and N11. The channel from which the ink is discharged is referred to as a target channel, and a channel adjacent to the target channel is referred to as an adjacent channel. The ink jet head 21 discharge droplets on one dot on the print medium using the target channel and a pair of adjacent channels.

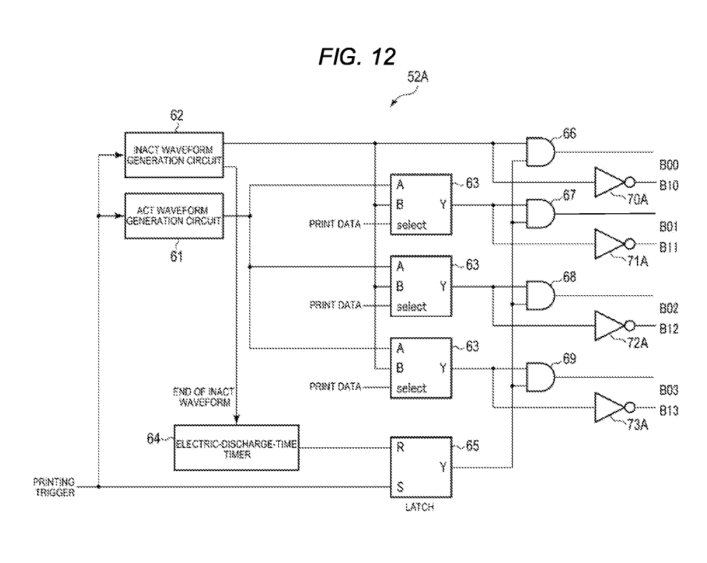

FIG. 11 is a timing chart of signals input to the drive circuit 53 by the drive control circuit 52. The signals BOO, B10, B01, B11, B02, and B12 are input waveforms applied to the buffers S00, S10, S01, S11, S02, and S12.

As illustrated in FIG. 11, between timing t1 and timing t2, waveforms are provided to the actuator 40 in a direction in which the electrode 38b is positive and the electrode 38a is negative. At the timing t1, a charge current starts flowing from a line at the power supply voltage VAA to the electrode 38b via transistors P00 and P02, charges the actuator 40, and flows out of the electrode 38a to GND via a transistor N11.

Between timing t2 and timing t3, waveforms for electric discharge are provided to the actuator 40. At the timing t2, a discharge current starts to flow from the electrode 38b to the electrode 38a via transistors P00 and P02, and then via the transistor P00, and discharges the actuator 40.

Between timing t3 and timing t4, waveforms are provided to the actuator in a direction in which the electrode 38b is negative and the electrode 38a is positive. At the timing t3, a charge current starts to flow from a line at the power supply voltage VAA to the electrode 38a via the transistor P01, charges the actuator 40, and flows out of the electrode 38b to GND via the transistors N10 and N12.

Between timing t4 and timing t5, waveforms for electric discharge are provided to the actuator 40. At the timing t4, a discharge current starts flowing from the electrode 38a to the electrode 38b via the transistor P01, and then via the transistors P00 and P02, and discharges the actuator 40.

That is, an electric charge current is generated at timing t1 and timing t3, and an electric discharge current is generated at timing t2 and timing t4. A latch circuit output is an output waveform of the latch circuit 65. The output waveform of the latch circuit 65 rises at timing t0 when a trigger pulse is input, and falls at timing t5.

The timing t5 is timing after a predetermined period of time counted by the electric-discharge-time timer 64 from the timing t4 corresponding to a falling end of the waveform INACT. In other words, it is assumed that the time required for the electric discharge equals to t5-t4, and the electric-discharge-time timer 64 is controlled to count the time period t5-t4.

At the timing t0, the drive control circuit 52 inputs a drive signal for bring the drive circuit 53 into a steady state to the drive circuit 53 when receiving the printing trigger from the head controller 22.

In the steady state, all of the P-type channel MOSFETs enter into an ON state and all of the N-type channel MOSFETs enter into an OFF state. The drive control circuit 52 outputs a high-level signal B01 and a low-level signal B11. As a result, the semiconductor switch P01 of the target channel is switched on, and the semiconductor switch N11 is switched off. Further, the drive control circuit 52 outputs a high-level signal BOO and a low-level signal B10. As a result, the semiconductor switch P00 of the adjacent channel is switched on, and the semiconductor switch N10 is switched off. Further, the drive control circuit 52 outputs a high-level signal B02 and a low-level signal B12. As a result, the semiconductor switch P02 of the adjacent channel is switched on, and the semiconductor switch N12 is switched off. Potentials of the electrode 38a of the target channel and the electrode 38b of the adjacent channel become the same voltage (+V) according to the power supply voltage VAA. Because the electrodes 38a and 38b adjacent to each other become the same voltage, deformation of the actuator 40 does not occur. At this time, the latch circuit 65 is in a state of outputting an ON signal (that is a high-level signal).

Next, the drive control circuit 52 inputs an ACT waveform for expanding the pressure chamber 43 to the drive circuit 53, causing the pressure chamber 43 to be expanded at the timing t1.

At the timing t1, the drive control circuit 52 outputs a low-level signal B01 and a high-level signal B11. Asa result, the semiconductor switch P01 of the target channel is switched off, and the semiconductor switch N11 is switched on. Further, the drive control circuit 52 outputs a high-level signal BOO and a low-level signal B10. As a result, the semiconductor switch P00 of the adjacent channel is switched on, and the semiconductor switch N10 is switched off. Further, the drive control circuit 52 outputs a high-level signal B02 and a low-level signal B12. As a result, the semiconductor switch P02 of the adjacent channel is switched on, and the semiconductor switch N12 is switched off. As a result, a potential of the electrode 38a of the target channel becomes GND, and a potential of the electrode 38b of the adjacent channel becomes +V. For this reason, the actuator 40 is deformed, the pressure chamber 43 is expanded as shown in FIG. 5A, and the ink is drawn into the pressure chamber 43a.

Next, the drive control circuit 52 inputs a drive signal for returning the drive circuit 53 to the steady state to the drive circuit 53 at the timing t2 at which the expansion of the pressure chamber 43 is completed.

The drive control circuit 52 outputs a high-level signal B01 and a low-level signal B11. As a result, the semiconductor switch P01 of the target channel is switched on, and the semiconductor switch N11 is switched off. Further, the drive control circuit 52 outputs a high-level signal BOO and a low-level signal B10. As a result, the semiconductor switch P00 of the adjacent channel is switched on, and the semiconductor switch N10 is switched off. Further, the drive control circuit 52 outputs a high-level signal B02 and a low-level signal B12. As a result, the semiconductor switch P02 of the adjacent channel is switched on, and the semiconductor switch N12 is switched off. Potentials of the electrode 38a of the target channel and the electrode 38b of the adjacent channel become the same voltage (+V) according to the power supply voltage VAA. Because the electrodes 38a and 38b adjacent to each other become the same voltage, the pressure chamber 43 returns to the original steady state from the expanded state. As a result, the pressure in the pressure chamber 43 increases, and ink is discharged.

Next, the drive control circuit 52 inputs the INACT waveform for contracting the pressure chamber 43 to the drive circuit 53 at the timing t3.

The drive control circuit 52 outputs a high-level signal B01 and a low-level signal B11. As a result, the semiconductor switch P01 of the target channel is switched on, and the semiconductor switch N11 is switched off. Further, the drive control circuit 52 outputs a low-level signal BOO and a high-level signal B10. As a result, the semiconductor switch P00 of the target channel is switched off, and the semiconductor switch N10 is switched on. Further, the drive control circuit 52 outputs a low-level signal B02 and a high-level signal B12. Asa result, the semiconductor switch P02 of the target channel is switched off, and the semiconductor switch N12 is switched on. A potential of the electrode 38a of the target channel becomes +V, and a potential of the electrode 38b of the adjacent channel becomes GND. For this reason, the actuator 40 is deformed, the pressure chamber 43 is contracted as shown in FIG. 5B, and the pressure in the pressure chamber 43 increases.

Next, the drive control circuit 52 inputs the drive signal for returning the drive circuit 53 to the steady state to the drive circuit 53 at the timing t4.

The drive control circuit 52 outputs a high-level signal B01 and a low-level signal B11. As a result, the semiconductor switch P01 of the target channel is switched on, and the semiconductor switch N11 is switched off. Further, the drive control circuit 52 outputs a high-level signal BOO and a low-level signal B10. As a result, the semiconductor switch P00 of the adjacent channel is switched on, and the semiconductor switch N10 is switched off. Further, the drive control circuit 52 outputs a high-level signal B02 and a low-level signal B12. As a result, one semiconductor switch P02 of the adjacent channel is switched on, and the semiconductor switch N12 is switched off. As a result, an electric discharge path is formed through which charges accumulated in the actuator 40 are electrically discharged via on—resistance of two semiconductor switches connected between the actuator 40 and the power supply voltage. The electric-discharge time, which is the time until the charges accumulated in the actuator 40 are completely discharged, is determined by a capacitance of the actuator 40 and an impedance of the electric discharge path. The drive control circuit 52 maintains the electric discharge path until the electric-discharge time has elapsed from when the supply of at least the INACT waveform is completed.

Next, the drive control circuit 52 inputs a drive signal for switching off all the P-type channel MOSFETs (which are the semiconductor switches connected between the power supply voltage and the actuator 40) of the drive circuit 53 to the drive circuit 53 at the timing t5 at which the electric discharge is completed.

The electric-discharge-time timer 64 of the drive control circuit 52 supplies a reset (R) signal to the latch circuit 65 when a time corresponding to the electric-discharge time has elapsed after the end of the INACT waveform. As a result, the latch circuit 65 outputs an OFF signal. As a result, each of the AND circuits in the drive control circuit 52 outputs an OFF signal, and each of the inverter circuits enters into a state of outputting an ON signal. Thus, the drive control circuit 52 outputs a low-level signal B01 and a high-level signal B11. Further, the drive control circuit 52 outputs a low-level signal BOO and a high-level signal B10. Further, the drive control circuit 52 outputs a low-level signal B02 and a high-level signal B12. As a result, the semiconductor switches P00, P01, and P02 are switched off, and the semiconductor switches N10, N11, and N12 are switched on.

According to the above-described configuration, the potentials of the electrode 38a and the electrode 38b of each channel are at the GND level. Even in the case the ink jet head 21 has a member that is in contact with the ink and is connected to the ground potential, it is possible to prevent electrophoresis in the ink because there is no voltage difference between the member and the electrode 38a and between the member and the electrode 38b after the timing t5. As a result, it is possible to realize prolongation of lifetime of the ink jet head.

In the example embodiment described above, the drive control circuit 52 switches off the semiconductor switch connected between the power supply voltage and the actuator 40 by the combination of the electric-discharge-time timer 64, the latch circuit 65, and the AND circuit, after the electric-discharge time has elapsed after returning from the contracted state to the steady state, but the present disclosure is not limited to this example. The drive control circuit 52 may set waveforms directly with respect to the ACT waveform generation circuit 61 and the INACT waveform generation circuit 62 after the timing t5, such that the semiconductor switch connected between the power supply voltage and the actuator 40 is switched off after the electric-discharge time has elapsed after returning from the contracted state to the steady state.

### Second Embodiment

An ink jet printer 1 according to a second embodiment will be described below. The second embodiment differs in the configuration of the drive control circuit from the first embodiment. The same reference symbol will be attached to the same elements and once described in reference to a drawing or otherwise repeated description may be omitted.

FIG. 12 is a diagram of a drive control circuit 52A according to the second embodiment.

The drive control circuit 52A generates a drive signal for each channel based on the print data and the printing trigger supplied from the register 51. The drive control circuit 52A supplies the generated drive signal to the drive circuit 53.

For example, the drive control circuit 52A combines an ACT waveform, an INACT waveform, and a steady state based on the print data, thereby generating a drive signal. The drive control circuit 52A includes an ACT waveform generation circuit 61, an INACT waveform generation circuit 62, a plurality of selectors 63, an electric-discharge-time timer 64, a latch circuit 65, a first AND circuit 66, a second AND circuit 67, a third AND circuit 68, a fourth AND circuit 69, a first inverter circuit 70A, a second inverter circuit 71A, a third inverter circuit 72A, and a fourth inverter circuit 73A. FIG. 12 illustrates a part of the drive control circuit 52A, and the drive control circuit 52A further includes a large number of selectors, AND circuits, and inverter circuits. For example, the drive control circuit 52A includes a selector, an AND circuit, and an inverter circuit for each channel.

The first AND circuit 66 is connected to an output terminal of the INACT waveform generation circuit 62 and an output terminal of the latch circuit 65. The first AND circuit 66 outputs an ON-signal when the signal from the INACT waveform generation circuit 62 is ON and the signal from the latch circuit 65 is ON. The signal from the first AND circuit 66 is supplied as a signal BOO to a buffer circuit of the drive circuit 53.

The first AND circuit 66 output an ON-signal when the signal of the INACT waveform generation circuit 62 is High and the signal from the latch circuit 65 is ON. The signal from the first AND circuit 66 is supplied as a signal BOO to the buffer circuit of the drive circuit 53.

The first inverter circuit 70A inverts the signal output from the INACT waveform generation circuit 62, and supplies the inverted signal as a signal B10 to the buffer circuit of the drive circuit 53.

The second AND circuit 67 is connected to an output terminal of the selector 63 and an output terminal of the latch circuit 65. The second AND circuit 67 output an ON-signal when the signal of the selector 63 is ON and the signal from the latch circuit 65 is ON. The signal from the second AND circuit 67 is supplied as a signal B01 to the buffer circuit of the drive circuit 53.

The second inverter circuit 71A inverts the signal output from the selector 63, and supplies the inverted signal as a signal B11 to the buffer circuit of the drive circuit 53. The second inverter circuit 71A inverts the signal output from the selector 63 that supplies a signal to the second AND circuit 67 and outputs the inverted signal.

The third AND circuit 68 is connected to the output terminal of the selector 63 and the output terminal of the latch circuit 65. The third AND circuit 68 outputs an ON-signal when the signal from the selector 63 is ON and the signal from the latch circuit 65 is ON. The signal from the third AND circuit 68 is supplied as a signal B02 to the buffer circuit of the drive circuit 53.

The third inverter circuit 72A inverts the signal output from the selector 63, and supplies the inverted signal as a signal B12 to the buffer circuit of the drive circuit 53. The third inverter circuit 72A inverts the signal output from the selector 63 that supplies a signal to the third AND circuit 68 and outputs the inverted signal.

The fourth AND circuit 69 is connected to the output terminal of the selector 63 and the output terminal of the latch circuit 65. The fourth AND circuit 69 outputs an ON-signal when the signal from the selector 63 is ON and the signal from the latch circuit 65 is ON. The signal from the fourth AND circuit 69 is supplied as a signal B03 to the buffer circuit of the drive circuit 53.

The fourth inverter circuit 73A inverts the signal output from the selector 63, and supplies the inverted signal as a signal B13 to the buffer circuit of the drive circuit 53. The fourth inverter circuit 73A inverts the signal output from the selector 63 that supplies a signal to the fourth AND circuit 69 and outputs the inverted signal.

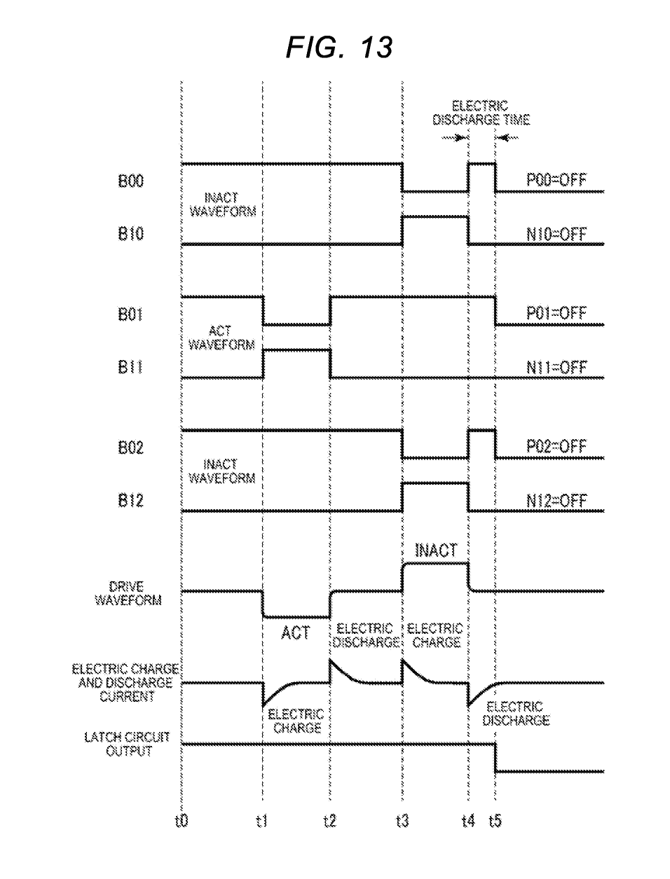

FIG. 13 is a timing chart of an example of signals input to the drive circuit 53 by the drive control circuit 52A. The signals BOO, B10, B01, B11, B02, and B12 are input waveforms applied to the buffers S00, S10, S01, S11, S02, and S12, respectively. As illustrated in FIG. 13, between timing t1 and timing t2, waveforms are provided to the actuator 40 in a direction in which the electrode 38b is positive and the electrode 38a is negative. At the timing t1, a charge current starts flowing from a line at the power supply voltage VAA to the electrode 38b via transistors P00 and P02, charges the actuator 40, and flows out of the electrode 38a to GND via a transistor N11.

Between timing t2 and timing t3, waveforms for electric discharge are provided to the actuator 40. At the timing t2, a discharge current starts to flow from the electrode 38b to the electrode 38a via transistors P00 and P02, and then via the transistor P00, and discharges the actuator 40.

Between timing t3 and timing t4, waveforms are provided to the actuator in a direction in which the electrode 38b is negative and the electrode 38a is positive. At the timing t3, a charge current starts to flow from a line at the power supply voltage VAA to the electrode 38a via the transistor P01, charges the actuator 40, and flows out of the electrode 38b to GND via the transistors N10 and N12.

Between timing t4 and timing t5, waveforms for electric discharge are provided to the actuator 40. At the timing t4, a discharge current starts flowing from the electrode 38a to the electrode 38b via the transistor P01, and then via the transistors P00 and P02, and discharges the actuator 40.

That is, an electric charge current is generated at timing t1 and timing t3, and an electric discharge current is generated at timing t2 and timing t4. A latch circuit output is an output waveform of the latch circuit 65. The output waveform of the latch circuit 65 rises at timing t0 (becomes an ON signal), and falls at timing t5. The timing t5 is timing after a predetermined period of time counted by the electric-discharge-time timer 64 from the timing t4 corresponding to a falling end of the waveform INACT. In other words, it is assumed that the time required for the electric discharge equals to t5-t4, and the electric-discharge-time timer 64 is controlled to count the time period t5-t4.

First, the drive control circuit 52A inputs a drive signal for bring the drive circuit 53 into a steady state to the drive circuit 53 when receiving the printing trigger from the head controller 22 at the timing t0.

The drive control circuit 52A outputs a high-level signal B01 and a low-level signal B11. As a result, the semiconductor switch P01 of the target channel is switched on, and the semiconductor switch N11 is switched off. Further, the drive control circuit 52A outputs a high-level signal BOO and a low-level signal B10. As a result, the semiconductor switch P00 of the adjacent channel is switched on, and the semiconductor switch N10 is switched off. Further, the drive control circuit 52A outputs a high-level signal B02 and a low-level signal B12. As a result, the semiconductor switch P02 of the adjacent channel is switched on, and the semiconductor switch N12 is switched off. Potentials of the electrode 38a of the target channel and the electrode 38b of the adjacent channel become the same voltage (+V) according to the power supply voltage VAA. Because the electrode 38a and the electrode 38b adjacent to each other become the same voltage, deformation of the actuator 40 does not occur. The latch circuit 65 is in a state of outputting an ON signal (a high-level signal).

Next, the drive control circuit 52A inputs an ACT waveform for expanding the pressure chamber 43 to the drive circuit 53 at the timing t1 at which the pressure chamber 43 is expanded.

The drive control circuit 52A outputs a low-level signal B01 and a high-level signal B11. As a result, the semiconductor switch P01 of the target channel is switched off, and the semiconductor switch N11 is switched on. Further, the drive control circuit 52A outputs a high-level signal BOO and a low-level signal B10. As a result, the semiconductor switch P00 of the adjacent channel is switched on, and the semiconductor switch N10 is switched off. Further, the drive control circuit 52A outputs a high-level signal B02 and a low-level signal B12. As a result, the semiconductor switch P02 of the adjacent channel is switched on, and the semiconductor switch N12 is switched off. As a result, the potential of the electrode 38a of the target channel becomes GND, and a potential of the electrode 38b of the adjacent channel becomes +V. For this reason, the actuator 40 is deformed, the pressure chamber 43 is expanded as shown in FIG. 5A, and the ink is drawn into the pressure chamber 43a.

Next, the drive control circuit 52A inputs a drive signal for returning the drive circuit 53 to the steady state to the drive circuit 53 at the timing t2 at which the expansion of the pressure chamber 43 is completed.

The drive control circuit 52A outputs a high-level signal B01 and a low-level signal B11. Asa result, the semiconductor switch P01 of the target channel is switched on, and the semiconductor switch N11 is switched off. Further, the drive control circuit 52A outputs a high-level signal BOO and a low-level signal B10. As a result, the semiconductor switch P00 of the adjacent channel is switched on, and the semiconductor switch N10 is switched off. Further, the drive control circuit 52A outputs a high-level signal B02 and a low-level signal B12. As a result, the semiconductor switch P02 of the adjacent channel is switched on, and the semiconductor switch N12 is switched off. Potentials of the electrode 38a of the target channel and the electrode 38b of the adjacent channel become the same voltage (+V) according to the power supply voltage VAA. Because the electrode 38a and the electrode 38b adjacent to each other become the same voltage, the pressure chamber 43 returns to the original steady state from the expanded state. As a result, the pressure in the pressure chamber 43 increases and ink is discharged.

Next, the drive control circuit 52A inputs the INACT waveform for contracting the pressure chamber 43 to the drive circuit 53 at the timing t3.

The drive control circuit 52A outputs a high-level signal B01 and a low-level signal B11. As a result, the semiconductor switch P01 of the target channel is switched on, and the semiconductor switch N11 is switched off. Further, the drive control circuit 52A outputs a low-level signal BOO and a high-level signal B10. As a result, one semiconductor switch P00 of the target channel is switched off, and the semiconductor switch N10 is switched on. Further, the drive control circuit 52A outputs a low-level signal B02 and a high-level signal B12. As a result, the semiconductor switch P02 of the target channel is switched off, and the semiconductor switch N12 is switched on. A potential of the electrode 38a of the target channel becomes +V, and a potential of the electrode 38b of the adjacent channel becomes GND. For this reason, the actuator 40 is deformed, the pressure chamber 43 is contracted as shown in FIG. 5B, and the pressure in the pressure chamber 43 increases.

Next, the drive control circuit 52A inputs the drive signal for returning the drive circuit 53 to the steady state to the drive circuit 53 at the timing t4.

The drive control circuit 52A outputs a high-level signal B01 and a low-level signal B11. As a result, the semiconductor switch P01 of the target channel is switched on, and the semiconductor switch N11 is switched off. Further, the drive control circuit 52A outputs a high-level signal BOO and a low-level signal B10. As a result, the semiconductor switch P00 of the adjacent channel is switched on, and the semiconductor switch N10 is switched off. Further, the drive control circuit 52A outputs a high-level signal B02 and a low-level signal B12. As a result, the semiconductor switch P02 of the adjacent channel is switched on, and the semiconductor switch N12 is switched off. An electric discharge path is formed through which charges accumulated in the actuator 40 are electrically discharged via on—resistance of two semiconductor switches connected between the actuator 40 and the power supply voltage. The electric-discharge time, which is the time until the charges accumulated in the actuator 40 are completely discharged, is determined by a capacitance of the actuator 40 and an impedance of the electric discharge path. The drive control circuit 52A maintains the electric discharge path until the electric-discharge time has elapsed from when the supply of at least the INACT waveform is completed.

Next, the drive control circuit 52A inputs a drive signal for switching off all the P-type channel MOSFETs (which are the semiconductor switches connected between the power supply voltage and the actuator 40) of the drive circuit 53 and for switching on all the N-type channel MOSFETs (which are the semiconductor switches connected between the GND and the actuator 40) to the drive circuit 53 at the timing t5 at which the electric discharge is completed.

The electric-discharge-time timer 64 of the drive control circuit 52A supplies a reset (R) signal to the latch circuit 65 when a time corresponding to the electric-discharge time has elapsed after the end of the INACT waveform. Then the latch circuit 65 outputs an OFF signal. As a result, each of the AND circuits in the drive control circuit 52A enters into a state of outputting an OFF signal. Further, in a steady state where the ACT waveform and the INACT waveform are output, each of the selectors 63 of the drive control circuit 52A enters into a state of outputting an ON signal. For this reason, each of the inverter circuits enters into a state of outputting an OFF signal. Thus, the drive control circuit 52A outputs a low-level signal B01 and a low-level signal B11. Further, the drive control circuit 52A outputs a low-level signal BOO and a low-level signal B10. Further, the drive control circuit 52A outputs a low-level signal B02 and a low-level signal B12. As a result, the semiconductor switches P00, P01, P02, N10, N11, N12 are switched off, and the drive circuit 53 enters into a high impedance state. In this manner, the drive control circuit 52A controls the output of the drive circuit 53 to high impedance after a predetermined time from the last change in the drive waveform.

According to the above-described configuration, both the electrode 38a and the electrode 38b of each channel enter into an open state. Even in the case the ink jet head 21 has a member that is in contact with the ink and is connected to the ground potential, it is possible to prevent electrophoresis in the ink because the electrode 38 forming the actuator 40 is in the open state. Asa result, it is possible to realize prolongation of lifetime of the ink jet head.

While some embodiments of the present invention have been described, these embodiments are merely examples, and are not intended to limit the scope of the invention. These novel embodiments may be implemented in various other forms, and various omissions, replacements, and modifications may be made without departing from the scope and spirit of the invention. These embodiments and the modifications are included in the scope and spirit of the invention, and are included in the invention described in the claims and their equivalents.

What is claimed is:

1. An ink jet head comprising:
a pressure chamber to be filled with ink;
an actuator configured to deform the pressure chamber;
first and second electrodes connected to the actuator;
a drive circuit including:
a first switch configured to turn on and connect a first power supply voltage to the first electrode;
a second switch configured to turn on and connect the first power supply voltage to the second electrode;
a third switch configured to turn on and connect the first electrode to a ground potential; and
a fourth switch configured to turn on and connect the second electrode to the ground potential; and
a nozzle plate including a discharge nozzle through which the ink from the pressure chamber is discharged, wherein
the drive circuit is configured to:
expand the pressure chamber to an expanded state, by switching the first switch off and the third switch on,
contract the pressure chamber to a contracted state, by switching the first switch on and the third switch off and the second switch off and the fourth switch on,
cause the pressure chamber to return to a steady state by switching the first switch and the second switch on and switching the third switch and the fourth switch off, and
switch the first switch and the second switch off after the pressure chamber has returned to the steady state and a predetermined time has elapsed.

2. The ink jet head according to claim 1, wherein the drive circuit switches the third switch and the fourth switch on after the pressure chamber has returned to the steady state and the predetermined time has elapsed.

3. The ink jet head according to claim 1, wherein the drive circuit switches the third switch and the fourth switch off after the pressure chamber has returned to the steady state and the predetermined time has elapsed.

4. The ink jet head according to claim 1, wherein the first switch and the second switch are p-type channel field effect transistors.

5. The ink jet head according to claim 1, wherein the third switch and the fourth switch are n-type channel field effect transistors.

6. The ink jet head according to claim 1, wherein the drive circuit determines the predetermined time based on a capacitance of the actuator.

7. An ink jet head comprising:
a pressure chamber to be filled with ink;
an actuator configured to deform the pressure chamber;
first and second electrodes connected to the actuator;
a drive circuit connected to the first electrode and configured to apply a drive waveform to the first electrode; and
a control circuit configured to control an output of the drive circuit to a high impedance after a predetermined time has elapsed from a last change in the drive waveform.

8. The ink jet head according to claim 7, wherein
the drive circuit includes:
a first switch configured to turn on and connect a first power supply voltage to the first electrode; and
a second switch configured to turn on and connect the first electrode to a ground potential, and
the control circuit switches off the first and second switches after a preset time has elapsed from the last change in the drive waveform.

9. The ink jet head according to claim 8, wherein the first switch is p-type channel field effect transistors.

10. The ink jet head according to claim 8, wherein the second switch is n-type channel field effect transistors.

11. The ink jet head according to claim 8, wherein the control circuit determines the predetermined time based on a contracted state the actuator.

12. The ink jet head according to claim 8, wherein the control circuit determines the predetermined time based on a capacitance of the actuator and an impedance of an electric discharge path connected to the actuator.

13. An ink jet printer, comprising:
a conveyance motor configured to convey a print medium;
a pressure chamber to be filled with ink;
an actuator configured to deform the pressure chamber;
first and second electrodes connected to the actuator;
a drive circuit including:
a first switch configured to turn on and connect a first power supply voltage to the first electrode;
a second switch configured to turn on and connect the first power supply voltage to the second electrode;
a third switch configured to turn on and connect the first electrode to a ground potential; and
a fourth switch configured to turn on and connect the second electrode to the ground potential; and
a nozzle plate including a discharge nozzle through which the ink from the pressure chamber is to be discharged, wherein
the drive circuit is configured to:
expand the pressure chamber to an expanded state, by switching the first switch off and the third switch on,
contract the pressure chamber to a contracted state, by switching the first switch on, the third switch off, the second switch off and the fourth switch on, and
cause the pressure chamber to return to a steady state by switching the first switch and the second switch on and switching the third switch and the fourth switch off, and
switch the first switch and the second switch off after the pressure chamber has returned to the steady state and a predetermined time has elapsed.

14. The ink jet printer according to claim 13, wherein the drive circuit switches the third switch and the fourth switch on after the pressure chamber has returned to the steady state and the predetermined time has elapsed.

15. The ink jet printer according to claim 13, wherein the drive circuit switches the third switch and the fourth switch off after the pressure chamber has returned to the steady state and the predetermined time has elapsed.

16. The ink jet printer according to claim 13, wherein the first switch and the second switch are p-type channel field effect transistors.

17. The ink jet printer according to claim 13, wherein the third switch and the fourth switch are n-type channel field effect transistors.

18. The ink jet printer according to claim 13, wherein the drive circuit determines the predetermined time based on a capacitance of the actuator.

19. The ink jet printer according to claim 13, wherein the drive circuit determines the predetermined time based on a capacitance of the actuator and an impedance of an electric discharge path connected to the actuator.
